(19) United States
(12) Patent Application Publication
(10) Pub. No.: US 2009/0191454 A1
(43) Pub. Date: Jul. 30, 2009

(54) Pivotally actuated battery clamp terminal

(76) Inventors: Gary C. Detter, Berlin Center, OH (US); Jay H. Garretson, Warren, OH (US)

Correspondence Address: DELPHI TECHNOLOGIES, INC., M/C 480-410-202, PO BOX 5052, TROY, MI, 48007, US

(21) Appl. No.: 12/011,830

(22) Filed: Jan. 30, 2008

(51) Int. Cl. H01M 2/26; H01R 43/16

(52) U.S. Cl. 429/121; 29/874

(57) ABSTRACT

A battery clamp includes a fixed collar cooperating with an adjustable collar to engage a battery terminal. In one embodiment, the adjustable collar is attached to a pivotal grip plate, the pivotal grip plate being pivotably engageable with a base attached to the fixed collar. A method of securing a battery clamp about a terminal includes positioning a clamp around a terminal of a battery, wherein the clamp includes a fixed collar and an adjustable collar. The method further includes engaging the fixed collar and the adjustable collar to the terminal of the battery by adjusting the force applied by the adjustable collar.

### FIELD

The present embodiments generally relate to battery clamps used to connect battery terminals to electrical connectors of a machine.

### BACKGROUND

Batteries are used in a wide variety of applications ranging from handheld devices and small electronics to automobiles and large industrial machinery (collectively “devices”). The devices are generally connected to positive and negative battery terminals (often referred to as battery posts) through an electrical conductor such as a wire or coax cable. The electrical conductor is often secured to the battery posts using some type of battery clamp assembly that establishes a firm electrical connection between the battery post and a terminal end of the electrical conductor. The quality of the electrical connection between the battery and the device is often dependent on the quality and durability of battery clamp assembly.

Batteries are often subject to vibration and environmental contaminants that can over time loosen the connection point between the battery posts and the clamp assemblies. Eventually, the clamp assembly may completely disengage from the battery post, terminating the electrical connection. In many applications the terminal connection to the battery posts is accomplished using a horizontal bolt and trapped nut combination. This type of clamp assembly is generally difficult to assemble, particularly when the battery is located in close proximity to surrounding structures, which limits the space necessary to access and tighten the bolt.

Accordingly, the embodiments described herein were developed in light of these and other drawbacks associated with known battery clamps.

### SUMMARY

A battery clamp includes a fixed collar cooperating with an adjustable collar to engage a battery terminal. In one embodiment, the adjustable collar is attached to a pivotal grip plate, the pivotal grip plate being pivotably engageable with a base attached to the fixed collar.

A method of securing a battery clamp about a terminal includes positioning a clamp around a terminal of a battery, wherein the clamp includes a fixed collar and an adjustable collar. The method further includes engaging the fixed collar and the adjustable collar to the terminal of the battery by adjusting the force applied by the adjustable collar.

### BRIEF DESCRIPTION OF THE DRAWINGS

The foregoing brief description will be understood more completely from the following detailed description of the exemplary drawings, in which:

FIG. 1 is a perspective view of a battery clamp positioned on a battery;

FIG. 2 is an exploded view of the individual components of an alternative embodiment of a battery clamp;

FIG. 3 is a cross-sectional view of the battery clamp of FIG. 1.

### DETAILED DESCRIPTION

A battery clamp includes a fixed collar cooperating with an adjustable collar to engage a battery post terminal along an axis generally parallel to side walls of the battery post. In one embodiment, the adjustable collar includes a pivotal grip plate having a nut and bolt combination that is tightened and accessible along the parallel axis. The pivotal grip plate is configured to cooperate with the fixed collar such that the resulting clamping pressure is pivotally transferred to a gripping force around the battery post, perpendicular to the parallel axis. The pivotal actuation of the adjustable collar onto the side walls of the battery post terminal provides a constant and tight contact pressure that establishes a firm electrical connection between the battery clamp and the battery post terminal. In one embodiment, the pivotal grip plate includes a compression tab interacting at a pivot point with the fixed collar portion of the clamp. The compression tab provides a constant, slightly angular pressure force that helps to maintain a tight compression fit between the battery post and the battery clamp.

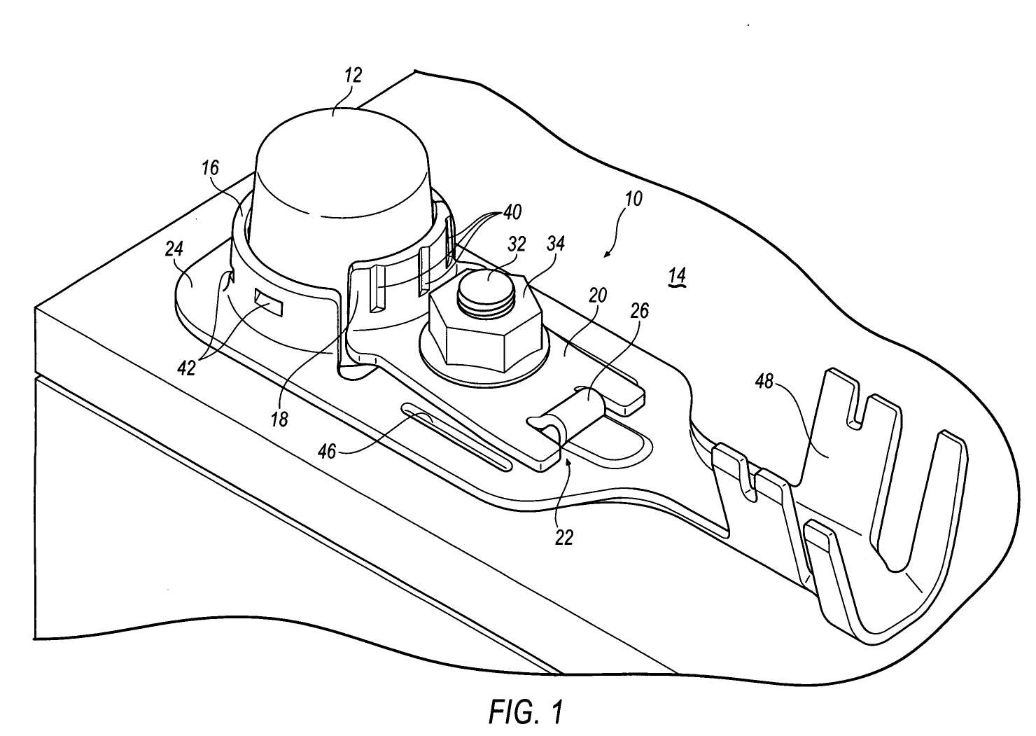

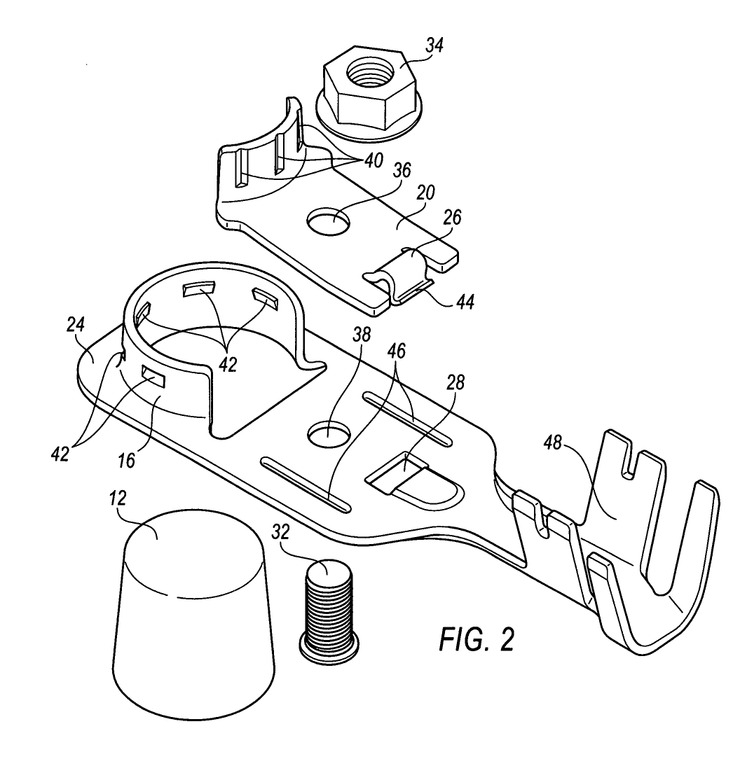

FIG. 1 illustrates an exemplary battery clamp 10 mounted to a post terminal 12 of a battery 14. The battery clamp 10 includes a fixed collar portion 16 that cooperates with an adjustable collar 18 to engage the battery post terminal 12. In one embodiment, the adjustable collar 18 includes a pivotal grip plate 20 extending from a base of the adjustable collar 18 to a pivot point 22 from which the pivotal grip plate 20 attaches to a base 24 of the fixed collar portion 16. The pivotal grip plate 20 further includes a compression tab 26 disposed at an opposite end the adjustable collar 18 at pivot point 22. The compression tab 26 interacts with the base 24 of the fixed collar portion 16 through a slot 28 (see FIG. 2). The compression tab 26 pivotably engages the slot 28 so that the pivotal grip plate 20 pivots about an edge of the slot 28 when a force is applied. In one embodiment, the force is applied to the pivotal grip plate 20 through a fastener 30. In the embodiment shown in FIGS. 1 and 2, the fastener 30 is a nut 32 and bolt 34 combination, however, one of ordinary skill in the art understands that other fastening mechanisms may be used. The compression force is created when the bolt 34 is tightened onto the nut 32, traversing both the pivotal grip plate 20 and the base 24 through respective corresponding openings 36 and 38 (FIG. 2).

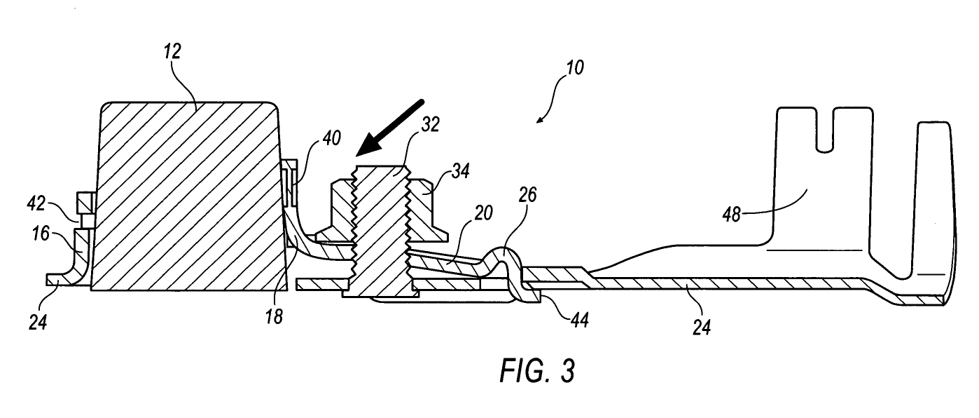

FIG. 2 illustrates an exploded view of the exemplary battery clamp 10 according to FIG. 1. FIG. 3 illustrates a side view of an assembled battery clamp 10 according to FIGS. 1 and 2. In each of the FIGS., the adjustable collar 18 is substantially perpendicular to the pivotal grip plate 20. The adjustable collar 18 is configured to make surface contact with a portion of the terminal 12 as depicted in FIGS. 1 and 3. It is contemplated that the adjustable collar 18 may make surface contact with more or less of the terminal 12, depending on the area that is in surface contact with the fixed collar 16. One of ordinary skill in the art understands that the width of both the fixed collar 16 and the adjustable collar 18 about the post terminal 12 may vary and is not limited to the embodiment shown in FIGS. 1-3. For example, in one exemplary embodiment, the fixed collar 16 may surround approximately seventy-five percent of the side wall surface area of the post terminal 12, while the adjustable collar 18 may surround approximately twenty-five percent.

In one embodiment of battery clamp 10, the adjustable collar 18 contains a plurality of gripping ribs 40. The gripping ribs 40 are substantially parallel to and integrally formed with the adjustable collar 18. The gripping ribs 40 may be spaced out randomly or evenly along the adjustable collar 18. The gripping ribs 40 function at least in part to promote the secure surface contact with the post terminal 12 facilitating conductivity through a strong and constant electrical connection. It is contemplated that there may be any number of gripping ribs 40 integrated into the adjustable collar 18. It is further contemplated that the length and width of the gripping ribs 40 may vary.

The fixed collar 16 is shaped to substantially match the contours of the post terminal 12. The fixed collar 16 should fit snuggly about the post terminal 12 to promote steady surface contact. The fixed collar 16 surrounds a substantial portion of the terminal 12 as depicted in FIG. 1. However, it is contemplated that the fixed collar 16 may surround more or less of the surface of the terminal 12 depending on the size of the terminal 12 and the fixed collar 16. It is further contemplated that the fixed collar 16 may be adapted to fit around varying shapes and sizes of different battery terminals depending on the make and manufacturer of the battery. For example, the fixed collar 16 may extend higher on the terminal 12 than as depicted in FIG. 1.

As shown in FIGS. 1 and 2, the fixed collar 16 may also contain a plurality of teeth 42. As illustrated in FIG. 2, the teeth 42 are textured portions of the fixed collar 16 that are integrally formed with the walls of fixed collar 16. The teeth 42 function in part to secure the fixed collar 16 against the walls of the terminal 12 by providing additional gripping force when the fastener 30 is tightened. It is contemplated that the teeth 42 can vary in length and width according to the size of the fixed collar 16 and the post terminal 12. It is also contemplated that the texture of the teeth 42 may vary to adapt to any number of battery terminal surfaces, if necessary. For example, although FIG. 2 illustrates five teeth 42, it is contemplated that other embodiments may have any number of teeth 42.

As shown in FIGS. 1-3, the base 24 and the pivotal grip plate 20 are substantially parallel to one another, with the pivotal grip plate 20 slightly angled to the base 24, as illustrated in FIG. 3. The acute angle formed by the arrangement of the pivotal grip plate 20 and the base 24 decreases as the fastener 30 is tightened. Both the base 24 and the pivotal grip plate 20 work together to facilitate the pivotal motion at the edge of the slot 28, which results in the secure surface contact with the terminal 12. As illustrated in FIGS. 2 and 3, a small area of the base 24 adjacent to the slot 28 is slightly raised to assist in part with the pivotal movement of the compression tab 26 about the edge of the slot 28. However, other embodiments are contemplated where this surface may not be raised.

In one embodiment, the compression tab 26 is integrally formed with the pivotal grip plate 20. The compression tab 26 is positioned between two flattened extensions in a plane of the pivotal grip plate 20. The compression tab 26 is configured to have a raised curvature that forms an arch above the plane with an extension that dips below the plane of the pivotal grip plate 20. At the end of this extension, there is a lip 44 that corresponds to the edge of the slot 28 and fits into the slot 28. The lip 44 may be substantially flat as illustrated in FIG. 3 or have a curved formation as illustrated in FIG. 2. As the fastener 30 is tightened, the compression force facilitates the pivoting of the compression tab 26 about the edge of the slot 28. After pivoting, the compression tab 26 is extended through the slot 28 and the lip 44 and is extended below a plane of the base 24. The arch of the compression tab 26 remains above the plane of the base 24. The flattened extensions of the pivotal grip plate 20 also remain above the plane of the base 24. The flattened extensions function at least in part to support and steady the pivotal grip plate 20 during the tightening and pivotal motion.

The base 24, as depicted in FIGS. 1-3, is substantially flat with one or more ridges 46 that protrude outward from the base 24. The ridges 46 function in part to further secure the pivotal grip plate 20 in place as it is tightened into position by at least partially preventing unwanted lateral motion on the base 24. The ridges 46 may also add additional stability to the base 24. Other embodiments are contemplated that include any number of ridges 46 or no ridges at all. If present, the ridges 46 may span a length to substantially match that of the pivotal grip plate 20, as depicted, or be divided into shorter-length ridges 46 that only span a portion of the base 24.

At an end of the base 24 opposite the fixed collar 16 is a crimping claw 48. The crimping claw 48 is generally integrally formed with the base 24 and has a U-shaped channel formation, as depicted in FIGS. 1-3. The crimping claw 48 U-shape has sides that are uneven in length and that have notches at the edges as illustrated. The crimping claw 48 is adapted to receive and support any electrical connectors that travel from the terminal 12 to an electrical component of, for example, an automobile, that requires a battery charge. Such connectors include, for example, wires and cables. The sides of the crimping claw 48 may be folded over onto each other and over the connectors being supported by the crimping claw 48, further securing the connectors into place and facilitating a steady and constant electrical connection between the terminal 12 and the electrical component. Again as appreciated by those skilled in the art, the crimping claw 48 may be of any design, depth, or width without deviating from the scope of the subject invention.

The appended claims have been particularly shown and described with reference to the foregoing embodiments, which are merely illustrative of the best modes for carrying out the invention defined by the appended claims. It should be understood by those skilled in the art that various alternatives to the embodiments described herein may be employed in practicing the invention defined by the appended claims without departing from the spirit and scope of the invention as defined in claims. The embodiments should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

With regard to the processes, methods, heuristics, etc. described herein, it should be understood that although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes described herein are provided for illustrating certain embodiments and should in no way be construed to limit the appended claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

What is claimed is:

1. A battery clamp, comprising:
a fixed collar cooperating with an adjustable collar to engage a battery terminal.

2. The battery clamp of claim 1, wherein the adjustable collar is attached to a pivotal grip plate, the pivotal grip plate being pivotably engageable with a base attached to the fixed collar.

3. The battery clamp of claim 2, further comprising a fastener adapted to apply a compression force against the pivotal grip plate, wherein tightening the fastener secures the pivotal grip plate to the base to make surface contact with the terminal.

4. The battery clamp of claim 3, wherein the fastener traverses respective corresponding openings in the base and the pivotal grip plate.

5. The battery clamp of claim 3, wherein the fastener comprises a threaded nut and a corresponding threaded bolt.

6. The battery clamp of claim 1, wherein the fixed collar further comprises a plurality of teeth engageable with the terminal.

7. The battery clamp of claim 1, wherein the adjustable collar further comprises at least one gripping rib engageable with the terminal.

8. The battery clamp of claim 2, wherein the base further comprises a slot adapted to receive a tab of the pivotal grip plate, the tab being adapted to pivot about an edge of the slot.

9. The battery clamp of claim 8, wherein the tab has a lip that is substantially flat.

10. The battery clamp of claim 2, wherein the base further comprises at least one ridge adapted to at least partially prevent lateral motion of the pivotal grip plate on the base during tightening of the fastener.

11. The battery clamp of claim 2, wherein the base further comprises a crimping claw adapted to receive at least one conductor.

12. The battery clamp of claim 11, wherein the crimping claw has a U-shaped channel formation with one or more sides with uneven edges.

13. The battery clamp of claim 1, wherein the terminal is a post battery terminal.

14. A method of securing a battery clamp about a terminal, comprising:
positioning a clamp around a terminal of a battery, wherein the clamp includes a fixed collar and an adjustable collar;
engaging the fixed collar and the adjustable collar to the terminal of the battery by adjusting the force applied by the adjustable collar.

15. The method of claim 14, wherein adjusting the force applied to the adjustable collar includes tightening a fastener about a pivot point between the fixed and adjustable collar.
